(19) United States
(12) Patent Application Publication
(10) Pub. No.: US 2009/0066617 A1
(43) Pub. Date: Mar. 12, 2009

(54) ACTIVE-MATRIX ORGANIC LIGHT EMITTING DIODE DISLAY

(75) Inventors: Meng-Hsiang CHANG, Hsinchu (TW); Chi-Wen CHEN, Hsinchu (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: AU OPTRONICS CORP., Hsinchu (TW)

(21) Appl. No.: 12/197,500

(22) Filed: Aug. 25, 2008

(30) Foreign Application Priority Data
Sep. 6, 2007 (TW) 096133217

(51) Int. Cl. G09G 3/32

(52) U.S. Cl. 345/83; 345/82

(57) ABSTRACT

An embodiment of an active-matrix organic light emitting diode (OLED) display is disclosed. The display includes a pixel array including a plurality of pixels, wherein each pixel includes a light emitting device, a driving device and a selection device. The light emitting device includes a first organic light emitting diode, a second organic light emitting diode and a third organic light emitting diode, wherein the diodes are stacked formed in the pixel. The driving device is coupled to a voltage source and receives an enable signal and a display data to drive the light emitting device. The selection device selects and turns on a corresponding organic light emitting diode based on a control signal.

### CROSS REFERENCE TO RELATED APPLICATIONS

This Application claims priority of Taiwan Patent Application No. 96133217, filed on Sep. 6, 2007, the entirety of which is incorporated by reference herein.

### BACKGROUND OF THE INVENTION

1. Field of the Invention

The invention relates to a display, and more particularly to an active-matrix organic light emitting diode (OLED) display.

2. Description of the Related Art

Organic light emitting diodes (OLED) have a number of advantages, such as self illumination, lower driving voltage, lower power consumption, less responding time, high luminance, high contrast, wide viewing angles, full color, lightweight, and wide operation temperature range. Thus, OLEDs have the potential to monopolize the flat panel display industry. The aperture ratio of the conventional OLED pixel is low due to the thin film transistors and data lines utilized. If luminance of the conventional OLED pixel wants to be increased, the current applied to the OLED pixel has to be increased. However, if current applied to the OLED pixel increases, the operating lifespan of the OLED pixel is reduced. FIG. 1 is a schematic diagram of a conventional OLED pixel. Pixel 11 comprises a first thin film transistor 12 (hereinafter referred as TFT 1), an red OLED 13, a second thin film transistor 14 (hereinafter referred as TFT 2), an green OLED 15, a third thin film transistor 16 (hereinafter referred as TFT 3), and an blue OLED 17. The transistors TFT 1, TFT 2 and TFT 3 respectively drives the red OLED 13, the green OLED 15 and the blue OLED 17. According to FIG. 1, it is shown that the area of each organic light emitting diode with a single color is small. Thus, with the aperture ratio of the organic light emitting diode with the signal color usually less than 10%, color shifting often occurs.

### BRIEF SUMMARY OF THE INVENTION

An embodiment of the present invention provides an active-matrix organic light emitting diode (OLED) display. The display comprises a pixel array comprising a plurality of pixels, wherein each pixel comprises a light emitting device, a driving device and a selection device. The light emitting device comprises a first organic light emitting diode, a second organic light emitting diode and a third organic light emitting diode, wherein the diodes are stacked formed in the pixel. The driving device is coupled to a voltage source and receives an enable signal and a display data to drive the light emitting device. The selection device selects and turns on a corresponding organic light emitting diode based on a control signal.

Another embodiment of present invention provides a active-matrix organic light emitting diode (OLED) display. The display comprises a pixel array, a gate driving circuit and a data driving circuit. The gate driving circuit outputs a control signal and an enable signal. The data driving circuit outputs a display data. The pixel array comprises a plurality of pixels, wherein each pixel comprises a light emitting device, a driving device and a selection device. The light emitting device comprises a first organic light emitting diode, a second organic light emitting diode and a third organic light emitting diode, wherein the diodes are stacked formed in the pixel. The driving device is coupled to a voltage source and receives an enable signal and a display data to drive the light emitting device. The selection device selects and turns on a corresponding organic light emitting diode based on a control signal.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a schematic diagram of the conventional OLED pixel.

FIG. 2 shows a pixel formed by stacked organic light emitting diodes.

FIG. 3 is a circuit diagram of an embodiment of the pixel according to the invention.

FIG. 4 is a circuit diagram of another embodiment of the pixel according to the invention.

FIG. 5 is a circuit diagram of another embodiment of the pixel according to the invention.

FIG. 6 is a timing diagram of according to the driving device of FIG. 5.

FIG. 7 is a circuit diagram of another embodiment of the pixel according to the invention.

FIG. 8 is a timing diagram of according to the driving device of FIG. 7.

FIG. 9 is a schematic diagram of an embodiment of a display panel according to the invention.

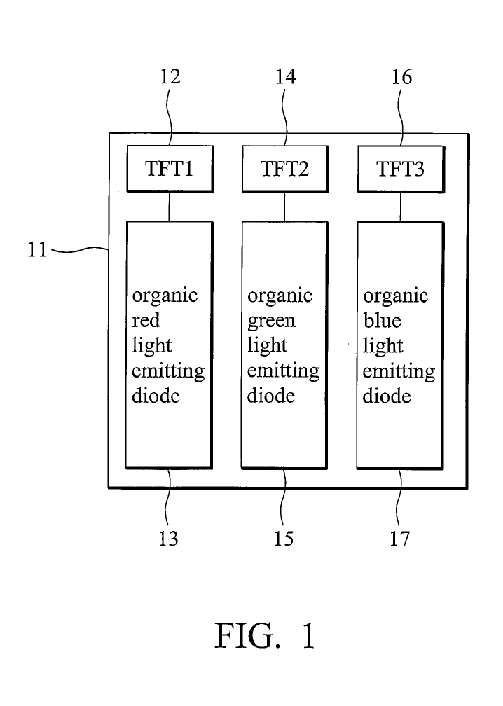

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

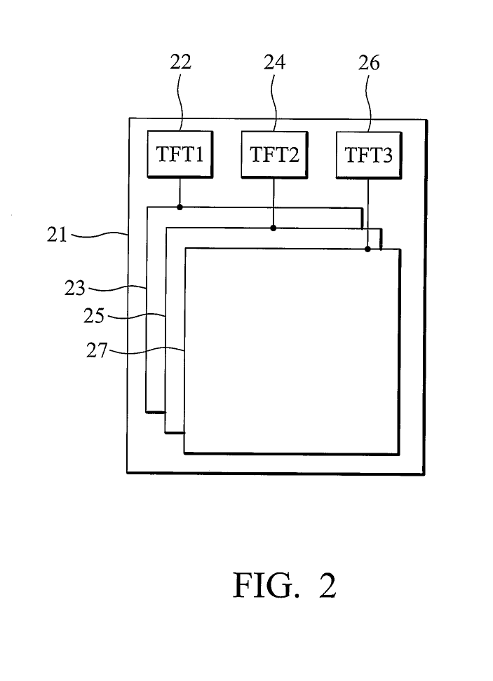

FIG. 2 shows a pixel formed by stacked organic light emitting diodes. The red OLED 23, the green OLED 25 and the blue OLED 27 form a stacked structure. The pixel 21 further comprises a first thin film transistor 22 (hereinafter referred as TFT 1), a second thin film transistor 24 (hereinafter referred as TFT 2) and a third thin film transistor 26 (hereinafter referred as TFT 3). The transistor TFT 1, TFT 2 and TFT 3 respectively drives the red OLED 23, the green OLED 25 and the blue OLED 27. Furthermore, the transistors TFT 1, TFT 2 and TFT 3 may respectively be in the same layer in which the red OLED 23, the green OLED 25 and the blue OLED 27 are disposed. The stacked organic light emitting diodes can increase the aperture ratio of the pixel and avoid color shifting.

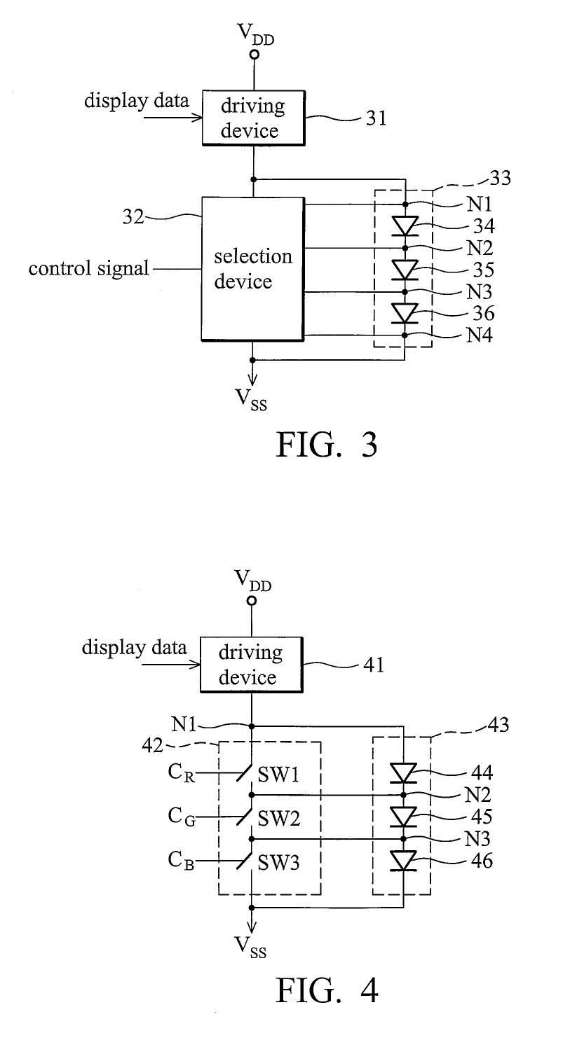

FIG. 3 is a circuit diagram of an embodiment of the pixel according to the invention. The pixel comprises a driving device 31 and a selection device 32 for driving the light emitting device 33. The light emitting device 33 comprises an red OLED 34, an green OLED 35 and an blue OLED 36. The driving device 31 is coupled to the voltage source V_{DD} and transmitted the display data, to the corresponding organic light emitting diode via the control signal and the selection device 32. The display data may be gray scale voltage to cause the light emitting diode to show different luminance. In one embodiment, the control signal comprises a first control signal, a second control signal and a third control signal. When the selection device 32 receives the first control signal, the selection device 32 selected a first path let the display data been shown by the red OLED 34. When the selection device 32 receives the second control signal, the selection device 32 c selected a first path let the display data been shown by the green OLED 35. When the selection device 32 receives the third control signal, the selection device 32 selected a first path let the display data been shown by the blue OLED 36. According to the described operation mechanism, the display data can be displayed by the corresponding organic light emitting diode. In the prefer embodiment, the display data may be a voltage signal or a current signal, and the luminance control of the organic light emitting diode can be implemented by adjusting the magnitude of the voltage signal or current signal.

FIG. 4 is a circuit diagram of another embodiment of the pixel according to the invention. The pixel comprises a driving device 41 and a selection device 42 for driving the light emitting device 43. The light emitting device 43 comprises an red OLED 44, an green OLED 45 and an blue OLED 46. The driving device 41 is coupled to the voltage source V_{DD} and transmitted the display data to the corresponding organic light emitting diode via the the selection device 42 according to the control signals C_{R}, C_{G}, C_{B}. The display data may be gray scale voltage to cause the light emitting diode to show different luminance. The control signals C_{R}, C_{G} and C_{B} control the switch to be on or off, corresponding to the organic light emitting diode which the display data is designated. For example, when the display data is designated as the red OLED 44, the control signal C_{R} turns the switch SW1 off (switches SW2 and SW3 are still turned on), and the current according to the display data is passed through the red OLED 44 via node N1. When the display data is designated as the green OLED 45, the control signal C_{G} turns the switch SW2 off (switches SW1 and SW3 are still turned on), and the display data is transmitted to the green OLED 45 via node N2. When the display data is designated as the blue OLED 46, the control signal C_{B} turns the switch SW3 off (switches SW1 and SW2 are still turned on), and the display data is transmitted to the blue OLED 46 via node N3.

According to the described operation mechanism, display data can be displayed by the corresponding organic light emitting diode, the display data may be a voltage signal or a current signal, and the luminance control of the organic light emitting diode can be implemented by adjusting the magnitude of the voltage signal or current signal or a PWM (Pulse Width Modulation signal, PWM) signal, and the luminance control of the organic light emitting diode can be implemented by adjusting the width or the duty cycle of the PWM signal.

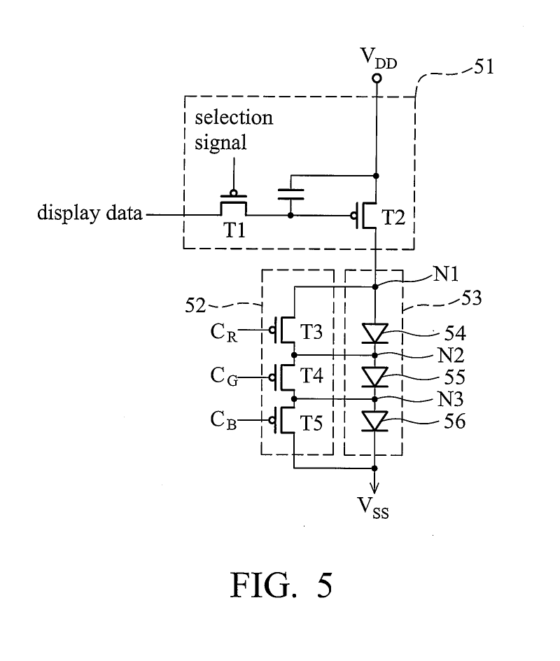

FIG. 5 is a circuit diagram of another embodiment of the pixel according to the invention. The pixel comprises a driving device 51 and a selection device 52 for driving the light emitting device 53. The light emitting device 53 comprises an red OLED 54, an green OLED 55 and an blue OLED 56. The driving device 51 is coupled to the voltage source V_{DD} to transmit the display data, to the corresponding organic light emitting diode via the control signals C_{R}, C_{G}, C_{B} and the selection device 52. The display data may be gray scale to cause the light emitting diode to show different luminance. The driving device 51 comprises a first transistor T1 and a second transistor T2. The first transistor T1 comprises a control terminal receiving the selection signal, an input terminal receiving the display data, and an output terminal. The second transistor T2 comprises a control terminal coupled to the output terminal of the first transistor T1, an input terminal coupled to a voltage source V_{DD}, and an output terminal. The transistor T1 is turned on when receiving the selection signal, the display data is then transmitted to the control terminal of the second transistor T2 to control the amount of the current passing through the second transistor T2, and the luminance of the light emitting device 53 can be controlled based on the amount of current fed into the light emitting device 53. The selection device 42 comprises a third transistor T3, a fourth transistor T4 and a fifth transistor T5. The transistors T3, T4 and T5 are initially turned on and the control signals C_{R}, C_{G} and C_{B} are initially set to low voltage signals. In one embodiment, transistors T3, T4 and T5 are PMOS transistors. The control signals C_{R}, C_{G} and C_{B} turn off the transistor corresponding to the organic light emitting diode in which the display data is designated. For example, when the display data is designated as the red OLED 54, the control signal C_{R} is changed to high voltage level and turns the transistor T3 off (transistors T4 and T5 are still turned on), and the display data is transmitted to the red OLED 54 via node N1. When the display data is designated as the green OLED 55, the control signal C_{G} is changed to high voltage level and turns the transistor T4 off (transistors T3 and T5 are still turned on), and the display data is transmitted to the green OLED 55 via node N2. When the display data is designated as the blue OLED 56, the control signal C_{B} is changed to high voltage level and turns the transistor T5 off (transistors T3 and T5 are still turned on), and the display data is transmitted to the blue OLED 56 via node N3.

According to the described operation mechanism, display data can be shown by the corresponding organic light emitting diode. In another embodiment, the display data may be a voltage signal or a current signal, and the luminance control of the organic light emitting diode can be implemented by adjusting the magnitude of the voltage signal or current signal. In another embodiment, the display data is PWM (Pulse Width Modulation signal, PWM) signal, and the luminance control of the organic light emitting diode can be implemented by adjusting the width or the duty cycle of the PWM signal.

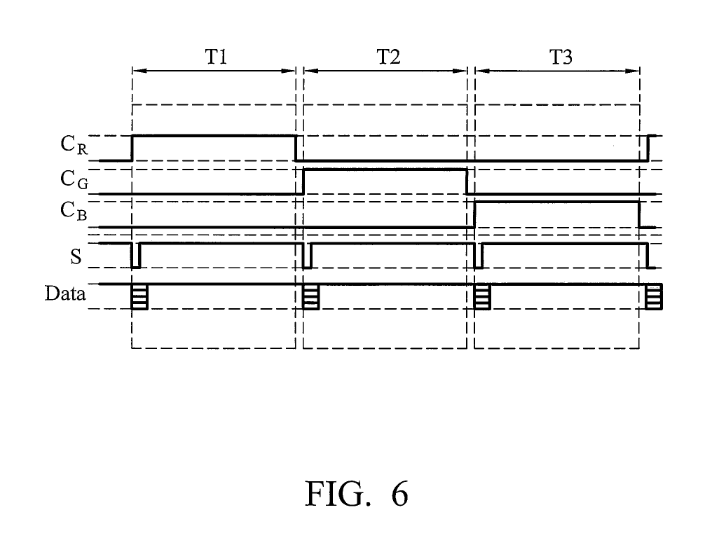

FIG. 6 is a timing diagram of according to the driving device of FIG. 5. During time period T1, the control signal C_{R} is asserted to de-activate the transistor T3, the enable signal S is de-asserted, and the display data is therefore transmitted and shown by the red OLED 54. During time period T2, the control signal C_{G} is asserted to de-activate the transistor T4, the enable signal S is de-asserted, and the display data is therefore transmitted and shown by the green OLED 55. During time period T3, the control signal C_{B} is asserted to de-activate the transistor T5, the enable signal S is de-asserted, and the display data is therefore transmitted and shown by the blue OLED 56. It is noted that a time period t exist between the time periods T1 and T2, and time periods T2 and T3. The time period t avoids color shifting or blurred frames which are caused by two organic light emitting diodes simultaneously emitting light; if the circuit constructed by NMOS, the timing diagram of the FIG. 6 will be inversed except the Data signal.

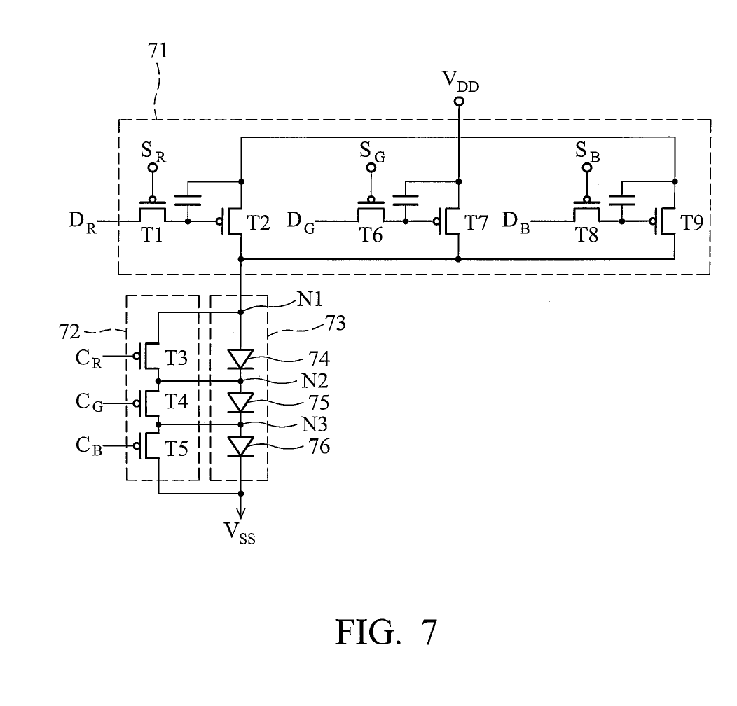

FIG. 7 is a circuit diagram of another embodiment of the pixel according to the invention. Compared with the pixel shown in FIG. 5, the display data is divided into red display data D_{R}, green display data D_{G} and blue display data D_{B}. The display time of the red display data D_{R}, green display data D_{G} and blue display data D_{B} shown by the corresponding organic light emitting diode is determined by the enable signals S_{R}, S_{G} and S_{B}. The driving device 71 comprises transistors T1, T2, T6, T7, T8 and T9. The transistor T1 comprises a control terminal receiving the enable signal S_{R}, an input terminal receiving the red display data D_{R}, and an output terminal. The transistor T2 comprises a control terminal coupled to the output terminal of transistor T1, an input terminal coupled to the voltage source V_{DD}, and an output terminal. The transistor T6 comprises a control terminal receiving the enable signal S_{G}, an input terminal receiving the green display data D_{G}, and an output terminal. The transistor T7 comprises a control terminal coupled to the output terminal of transistor T6, an input terminal coupled to the voltage source V_{DD}, and an output terminal. The transistor T8 comprises a control terminal receiving the enable signal S_{B}, an input terminal receiving the blue display data D_{B}, and an output terminal. The transistor T9 comprises a control terminal coupled to the output terminal of transistor T8, an input terminal coupled to the voltage source V_{DD}, and an output terminal.

The selection device 72 comprises transistors T3, T4 and T5. In this embodiment, transistors T3, T4 and T5 are PMOS transistors and the control signals C_{R}, C_{G} and C_{B} are initially set to low voltage signals. In another embodiment, transistors T3, T4 and T5 are NMOS transistors and the control signals C_{R}, C_{G} and C_{B} are initially set to high voltage signals. The control signals C_{R}, C_{G} and C_{B} control the switch, corresponding to the organic light emitting diode in which the display data is designated, to be on or off. In one embodiment, the control signals C_{R}, C_{G} and C_{B} are the inverted signals of the enable signals S_{R}, S_{G} and S_{B}. For example, when the display data is designated as the red OLED 74, the control signal C_{R} is changed to high voltage level and turns the transistor T3 off (transistors T4 and T5 are still turned on), and the display data is transmitted to the red OLED 74 via node N1. When the display data is designated as the green OLED 75, the control signal C_{G} is changed to high voltage level and turns the transistor T4 off (transistors T3 and T5 are still turned on), and the display data is transmitted to the green OLED 75 via node N2. When the display data is designated as the blue OLED 76, the control signal C_{B} is changed to high voltage level and turns the transistor T5 off (transistors T3 and T5 are still turned on), and the display data is transmitted to the blue OLED 76 via node N3.

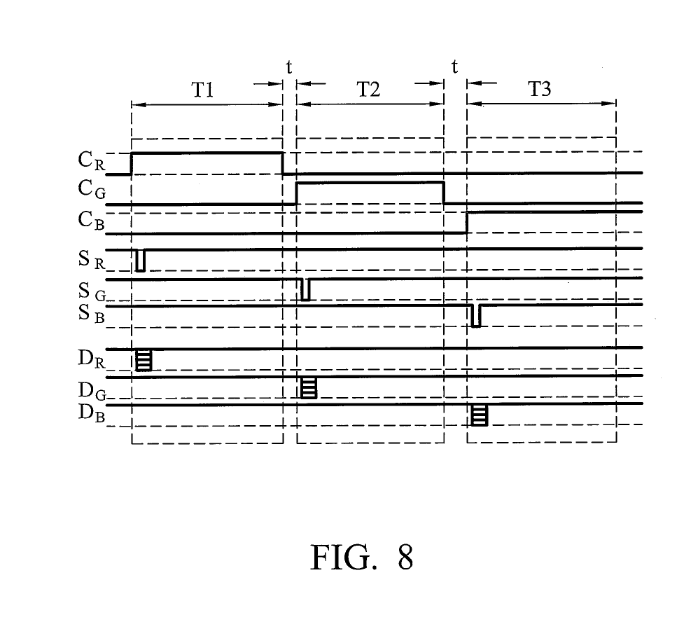

FIG. 8 is a timing diagram of according to the driving device of FIG. 7. During time period T1, the control signal C_{R} is asserted to de-activate the transistor T3, the enable signal S is de-asserted, and the display data is therefore transmitted and shown by the red OLED 74. During time period T2, the control signal C_{G} is asserted to de-activate the transistor T4, the enable signal S is de-asserted, and the display data is therefore transmitted and shown by the green OLED 75. During time period T3, the control signal C_{B} is asserted to de-activate the transistor T5, the enable signal S is de-asserted, and the display data is therefore transmitted and shown by the blue OLED 76. It is noted that a time period t exists between the time periods T1 and T2, and time periods T2 and T3. The time period t avoids color shifting or blurred frames which are caused by two organic light emitting diodes simultaneously emitting light. According to the timing diagram of FIG. 8, a display period T comprises time periods T1, T2, T3 and is twice the time period of t. If the display period T is 1/60 second, each time period T1, T2 or T3 is substantially less than 1/180 second.

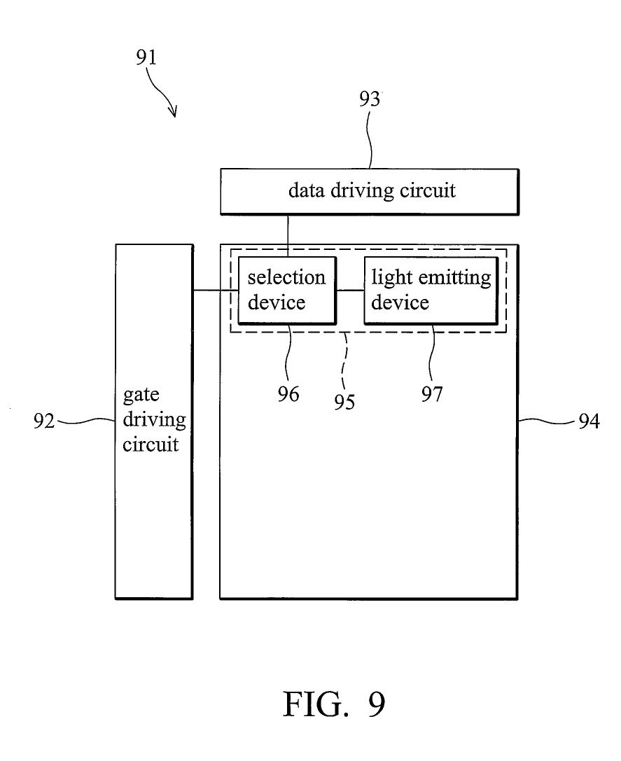

FIG. 9 is a schematic diagram of an embodiment of a display panel according to the invention. The display panel 91 comprises a gate driving circuit 92, a data driving circuit 93 and a pixel array 94. The pixel array 94 comprises a plurality of pixels, such as pixel 95, arranged in a matrix form, wherein each pixel comprises a selection circuit and a light emitting device. The circuit and operation of the pixel array 94 can be referred to in the descriptions of FIGS. 3-8. In this embodiment, each light emitting device, such as the light emitting device 97, is coupled to one selection device, such as the selection device 96. The selection circuit receives the display data from the data driving circuit 93 and the control signals from the gate driving circuit 92 to control the corresponding light emitting device showing the display data. In this embodiment, the selection circuit comprises the driving device 51 and the selection device 52 shown in FIG. 5. The gate driving circuit 92 generates the control signal and enable signal and transmits them to the corresponding pixel.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An active-matrix organic light emitting diode (OLED) display, comprising:
a pixel array comprising a plurality of pixels, wherein each pixel comprises:
a light emitting device, comprising a first organic light emitting diode, a second organic light emitting diode and a third organic light emitting diode, wherein the diodes are stacked formed in the pixel; and
a driving device coupled to a voltage source, to receive an enable signal and a display data to drive the light emitting device; and
a selection device to select and to turn on a corresponding organic light emitting diode based on a control signal.

2. The display as claimed in claim 1, wherein the selection device comprises a first switch, a second switch and a third switch respectively coupled to the first organic light emitting diode, the second organic light emitting diode and the third organic light emitting diode.

3. The display as claimed in claim 2, wherein the control signal comprises a first control signal, a second control signal and a third control signal respectively to control the first switch, the second switch and the third switch.

4. The display as claimed in claim 3, wherein the first control signal, the second control signal and the third control signal respectively turns on the first switch, the second switch and the third switch in a display period based on a time division multiplexing mechanism.

5. The display as claimed in claim 2, wherein the first switch is a first transistor having a first control terminal receiving the first control signal, a first input terminal coupled to a first anode of the first organic light emitting diode and a first output terminal coupled to a first cathode of the first organic light emitting diode.

6. The display as claimed in claim 2, wherein the second switch is a second transistor having a second control terminal receiving the second control signal, a second input terminal coupled to a second anode of the second organic light emitting diode and a second output terminal coupled to a second cathode of the second organic light emitting diode.

7. The display as claimed in claim 2, wherein the third switch is a third transistor having a third control terminal receiving the third control signal, a third input terminal coupled to a third anode of the third organic light emitting diode and a third output terminal coupled to a third cathode of the third organic light emitting diode.

8. The display as claimed in claim 1, wherein the first organic light emitting diode, the second organic light emitting diode and the third organic light emitting diode respectively are an red OLED, an green OLED and an blue OLED.

9. The display as claimed in claim 1, wherein the display data is a gray scale data for controlling the luminance of the light emitting device.

10. The display as claimed in claim 1, wherein the display data comprises a first display data, a second display data and a third display data.

11. The display as claimed in claim 10, wherein the driving device comprises a first driving device, a second driving device and a third driving device respectively driving the light emitting device based on the first display data, the second display data and the third display data.

12. The display as claimed in claim 11, wherein each driving device comprises:
a first transistor having a first control terminal receiving a selection signal for turning on/off the first transistor, a first input terminal receiving corresponding display data and a first output terminal;
a storage element coupled to the first output terminal; and
a second transistor having a second control terminal coupled to the first output terminal, a second input terminal coupled to the voltage source and a second output terminal coupled to the light emitting device.

13. The display as claimed in claim 12, wherein the first transistor and the second transistor are thin-film transistors.

14. The display as claimed in claim 11, wherein the first driving device, the second driving device and the third driving device respectively transmit the first display data, the second display data and the third display data to the light emitting device in a display period based on a time division multiplexing mechanism.

15. The display as claimed in claim 1, wherein the driving device is controlled by an enable signal and the driving device comprises:
a first transistor having a first control terminal receiving a selection signal for turning on/off the first transistor, a first input terminal receiving corresponding display data and a first output terminal;
a storage element coupled to the first output terminal; and
a second transistor having a second control terminal coupled to the first output terminal, a second input terminal coupled to the voltage source and a second output terminal coupled to the light emitting device.

16. An active-matrix organic light emitting diode (OLED) display, comprising:
a gate driving circuit to output a control signal and an enable signal;
a data driving circuit to output a display data; and
a pixel array comprising a plurality of pixels, wherein each pixel comprise:
a light emitting device, comprising a first organic light emitting diode, a second organic light emitting diode and a third organic light emitting diode, wherein the diodes are stacked formed in the pixel; and
a driving device coupled to a voltage source, to receive the enable signal and the display data to drive the light emitting device; and
a selection device to select and to turn on the corresponding organic light emitting diode based on the control signal.

17. The display as claimed in claim 16, wherein the driving device comprises a first driving device, a second driving device and a third driving device.

18. The display as claimed in claim 17, wherein each driving device comprises:
a first transistor having a first control terminal receiving a selection signal for turning on/off the first transistor, a first input terminal receiving corresponding display data and a first output terminal;
a storage element coupled to the first output terminal; and
a second transistor having a second control terminal coupled to the first output terminal, a second input terminal coupled to the voltage source and a second output terminal coupled to the light emitting device, wherein the second transistor controls the current magnitude applied to the light emitting device based on the received display data.

19. The display as claimed in claim 16, wherein the enable signal sequentially enables the first driving device, the second driving device and the third driving device.

20. The display as claimed in claim 16, wherein the selection device comprises a first switch, a second switch and a third switch respectively parallel coupled to the first organic light emitting diode, the second organic light emitting diode and the third organic light emitting diode.

21. The display as claimed in claim 20, wherein the control signal turns on the first switch, the second switch and the third switch at different times during a display period.

22. The display as claimed in claim 16, wherein the display data comprises a first display data, a second display data and a third display data respectively transmitted to the light emitting device via a first driving device, a second driving device and a third driving device in the driving device.

23. The display as claimed in claim 16, wherein the first organic light emitting diode, the second organic light emitting diode and the third organic light emitting diode respectively are an red OLED, an green OLED and an blue OLED.

24. The display as claimed in claim 18, wherein the first transistor and the second transistor are thin-film transistors.

25. The display as claimed in claim 16, wherein the display data is a gray scale data for controlling the luminance of the light emitting device.

26. The display as claimed in claim 1, wherein the driving device is controlled by the enable signal and the driving device comprises:
a first transistor having a first control terminal receiving a selection signal for turning on/off the first transistor, a first input terminal receiving corresponding display data and a first output terminal;
a storage element coupled to the first output terminal; and
a second transistor having a second control terminal coupled to the first output terminal, a second input terminal coupled to the voltage source and a second output terminal coupled to the light emitting device.
